(19) United States
(12) Patent Application Publication
(10) Pub. No.: US 2023/0286497 A1
(43) Pub. Date: Sep. 14, 2023

(54) COLLISION AVOIDANCE DEVICE, COLLISION AVOIDANCE METHOD AND COLLISION AVOIDANCE PROGRAM

(71) Applicant: TOYOTA JIDOSHA KABUSHIKI KAISHA, Toyota-shi, Aichi-ken (JP)

(72) Inventor: Kazuki HIRAMOTO, Susono-shi (JP)

(73) Assignee: TOYOTA JIDOSHA KABUSHIKI KAISHA, Toyota-shi, Aichi-ken (JP)

(21) Appl. No.: 18/176,574

(22) Filed: Mar. 1, 2023

(30) Foreign Application Priority Data
Mar. 9, 2022 (JP) 2022-035796

(51) Int. Cl. B60W 30/09; B60W 50/14

(52) U.S. Cl. CPC B60W 30/09; B60W 50/14; B60W 2720/10; B60W 2554/20; B60W 2420/52; B60W 2050/143; B60W 2554/402

(57) ABSTRACT

A collision avoidance device comprising a radar device that detects an object around an own vehicle, and an electronic control unit that executes a collision avoidance assistance control to avoid a collision when it is determined that the own vehicle may collide with the object detected by the radar device, and the electronic control unit is configured, even if the radar device detects a moving object that moves in a direction approaching a trajectory of the own vehicle so as to cross the trajectory and it is determined that there is a risk of the own vehicle colliding with the moving object, to reduce a control amount of the collision avoidance assistance control when a stationary structure is detected on the trajectory by the radar device and it is determined that the moving object is approaching the stationary structure.

### CROSS-REFERENCE TO RELATED APPLICATION

This application claims priority to Japanese Patent Application No. JP2022-35796 filed on Mar. 9, 2022 the content of which is hereby incorporated by reference in its entirety into this application.

### BACKGROUND

### 1. Technical Field

The present disclosure relates to a collision avoidance device, a collision avoidance method and a collision avoidance program for a vehicle such as an automobile.

### 2. Description of the Related Art

A collision avoidance device includes a detection device that detects an object around an own vehicle, and an electronic controller that performs collision avoidance assistance control such as issuing of a warning and automatic deceleration to avoid a collision when it is determined that there is a risk of the own vehicle colliding with an object detected by the detection device.

For example, in Japanese Patent Application Laid-open No. 2009-198402, a collision avoidance device is described that includes as a detection device a radar device that detects another vehicle diagonally ahead of an own vehicle, and that determines whether or not there is a risk of the own vehicle colliding with another vehicle approaching from the side and performs collision avoidance assistance control when there is a risk of collision. According to this type of collision avoidance device, in a situation where the own vehicle and another vehicle approach an intersection along trajectories that intersect each other, the risk of the own vehicle colliding with the other vehicle approaching from the side can be reduced.

In a conventional collision avoidance device such as the collision avoidance device described in the Japanese Patent Application Laid-open publication, a radar device detects another vehicle, but the radar device cannot detect a height of the other vehicle. Therefore, even if another vehicle approaching from the side of the own vehicle is an automobile traveling on an elevated road, a train traveling on an elevated track, a monorail, or the like, it may be determined that there is a risk of the own vehicle colliding with another vehicle, and the collision avoidance assistance control may be performed unnecessarily. Accordingly, it is inevitable that an occupant or occupants will feel annoyed by an unnecessary warning and the vehicle will be unnecessarily decelerated.

It is conceivable to mount a radar device capable of detecting a height of another vehicle on the own vehicle in order to avoid unnecessary execution of collision avoidance assistance control. However, a radar device capable of detecting a height of another vehicle cannot help be an expensive radar device in which antenna elements are arranged at a plurality of positions with different heights.

The present invention provides a collision avoidance device, a collision avoidance method, and a collision avoidance program improved to reduce adverse effects caused by unnecessary execution of collision avoidance assistance control in a situation where a moving object such as another vehicle approaching from the side of an own vehicle moves at a position different in height from the own vehicle.

According to the present disclosure, a collision avoidance device is provided that comprises a radar device that detects an object around an own vehicle, and an electronic control unit that is configured to execute a collision avoidance assistance control to avoid a collision when it is determined that there is a risk of the own vehicle colliding with the object detected by the radar device.

The electronic control unit is configured, even if the radar device detects a moving object that moves in a direction approaching a trajectory of the own vehicle so as to cross the trajectory and it is determined that there is a risk of the own vehicle colliding with the moving object, to reduce a control amount of the collision avoidance assistance control when a stationary structure is detected on the trajectory by the radar device and it is determined that the moving object is approaching the stationary structure.

According to the present disclosure, a collision avoidance method is provided that comprises a step of acquiring information about an object around an own vehicle detected by a radar device, a step of determining whether or not there is a risk of the own vehicle colliding with the object detected by the radar device, and a step of performing collision avoidance assistance control for avoiding a collision when it is determined that there is the risk.

The collision avoidance method further comprises a step of determining, when a moving object that moves in a direction approaching a trajectory of the own vehicle so as to cross the trajectory is detected by the radar device and it is determined that there is a risk of the own vehicle colliding with the moving object, whether or not a stationary structure is detected on the trajectory by the radar device and whether or not the moving object is approaching the stationary structure, and a step of reducing a control amount of the collision avoidance assistance control when a stationary structure is detected on the trajectory by the radar device and it is determined that the moving object is approaching the stationary structure.

Further, according to the present disclosure, a collision avoidance program is provided that causes an electronic control unit mounted on an own vehicle to execute a step of acquiring information about an object around an own vehicle detected by a radar device, a step of determining whether or not there is a risk of the own vehicle colliding with the object detected by the radar device, and a step of performing collision avoidance assistance control for avoiding a collision when it is determined that there is the risk.

The collision avoidance program further comprises a step of determining, when a moving object that moves in a direction approaching a trajectory of the own vehicle so as to cross the trajectory is detected by the radar device and it is determined that there is a risk of the own vehicle colliding with the moving object, whether or not a stationary structure is detected on the trajectory by the radar device and whether or not the moving object is approaching the stationary structure, and a step of reducing a control amount of the collision avoidance assistance control when a stationary structure is detected on the trajectory by the radar device and it is determined that the moving object is approaching the stationary structure.

According to the collision avoidance device, the collision avoidance method and the collision avoidance program, even if the radar device detects a moving object that moves in a direction approaching a trajectory of the own vehicle so as to cross the trajectory and it is determined that there is a risk of the own vehicle colliding with the moving object, a control amount of the collision avoidance assistance control is reduced when a stationary structure is detected on the trajectory by the radar device and it is determined that the moving object is approaching the stationary structure.

Therefore, compared to where the control amount of the collision avoidance support control is not reduced, it is possible to reduce adverse effects caused by unnecessary avoidance assistance control in a situation where a moving object such as another vehicle approaching from the side of the own vehicle moves at a height position different from that of the own vehicle.

Moreover, since a radar device capable of detecting a height of another vehicle, for example, an expensive radar device having antenna elements arranged at a plurality of positions with different heights, is unnecessary, the collision avoidance device can be avoided from becoming expensive.

Note that the control amount of the collision avoidance assistance control may be reduced to zero. In that case, it is possible to prevent the collision avoidance assistance control from being performed, thereby preventing the occurrence of adverse effects due to the collision avoidance assistance control being unnecessarily performed.

Furthermore, when there is a danger that the own vehicle will collide with a moving object approaching from the side at a grade intersection, a stationary structure is not detected on a trajectory of the own vehicle and it is not determined that the moving object approaches the stationary structure. Therefore, the collision avoidance assistance control is performed, and accordingly, collision avoidance can be assisted by the collision avoidance assistance control.

In one aspect of the present disclosure, the electronic control unit is configured, when the radar device detects a stationary object on the trajectory of the own vehicle and it is determined that the stationary object extends across the trajectory beyond a width of a lane in which the own vehicle is traveling, to determine that the stationary object is a stationary structure.

According to the above aspect, when the radar device detects a stationary object on the trajectory of the own vehicle and it is determined that the stationary object extends across the trajectory beyond a width of a lane in which the own vehicle is traveling, it is determined that the stationary object is a stationary structure. Therefore, it is possible to prevent a road sign, a traffic light, a stopped large vehicle, etc., from being erroneously determined to be stationary structures and it is possible to accurately determine whether or not a moving object approaching from the side of the own vehicle is moving at a height position different from that of the own vehicle.

In another aspect of the present disclosure, the collision avoidance assistance control is a control for performing automatic acceleration/deceleration of the own vehicle so as to reduce the risk of the own vehicle colliding with the moving object, and the electronic control unit is configured to reduce a control amount of the control for performing the automatic acceleration/deceleration of the own vehicle.

According to the above aspect, a control amount of the control for performing the automatic acceleration/deceleration of the own vehicle so as to reduce the risk of the own vehicle colliding with a moving object is reduced. Therefore, it is possible to reduce an amount of acceleration/deceleration of the own vehicle that is not dependent on a driving operation of a driver, that is, a fluctuation of a vehicle speed that is not intended by the driver.

Further, in another aspect of the present disclosure, the electronic control unit is configured not to perform the automatic acceleration/deceleration of the own vehicle by reducing the control amount of the control for performing the automatic acceleration/deceleration to zero.

According to the above aspect, since the control amount of the automatic acceleration/deceleration control is reduced to zero, the automatic acceleration/deceleration control of the own vehicle is not performed. Therefore, it is possible to prevent a vehicle speed fluctuation unintended by the driver from occurring.

Further, in another aspect of the present disclosure, the collision avoidance support control is a control for issuing a warning to warn a driver that there is a risk of the own vehicle colliding with the moving object, and the electronic control unit is configured to reduce a control amount of the control for issuing the warning so that a degree of appeal of the warning is reduced.

According to the above aspect, a control amount of the control for issuing a warning is reduced so as to reduce a degree of appeal of the warning to warn the driver that there is a risk of the own vehicle colliding with a moving object. Therefore, since a degree of appeal of the warning is reduced by reducing the control amount of the control for issuing the warning, it is possible to reduce a possibility that an occupant or occupants will feel annoyed by an unnecessary warning.

Further, in another aspect of the present disclosure, the electronic control unit is configured not to issue a warning by reducing the control amount of the control for issuing a warning to zero.

According to the above aspect, a warning is not issued by reducing the control amount of the control for issuing a warning to zero. Therefore, it is possible to prevent the occupant or occupants from being annoyed by an unnecessary warning.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing an embodiment of a collision avoidance device according to the present disclosure;

FIG. 2 is a flow chart showing a collision avoidance control routine in the embodiment;

FIG. 3 is a flow chart showing a main part of a collision avoidance control routine in a modified example;

FIG. 4 is a diagram showing a situation in which an own vehicle and another vehicle as a moving object move in directions perpendicular to each other toward an intersection;

FIG. 5 is a diagram showing a situation in which another vehicle as a moving body moves in the same direction as the own vehicle in front of the own vehicle;

FIG. 6 is a diagram showing a situation in which a road that seems to intersect a road on which the own vehicle is traveling is an elevated road; and

FIG. 7 is a diagram showing a situation in which the own vehicle may collide with another vehicle at an intersection.

### DETAILED DESCRIPTION

The present disclosure will now be described in detail with reference to the accompanying drawings.

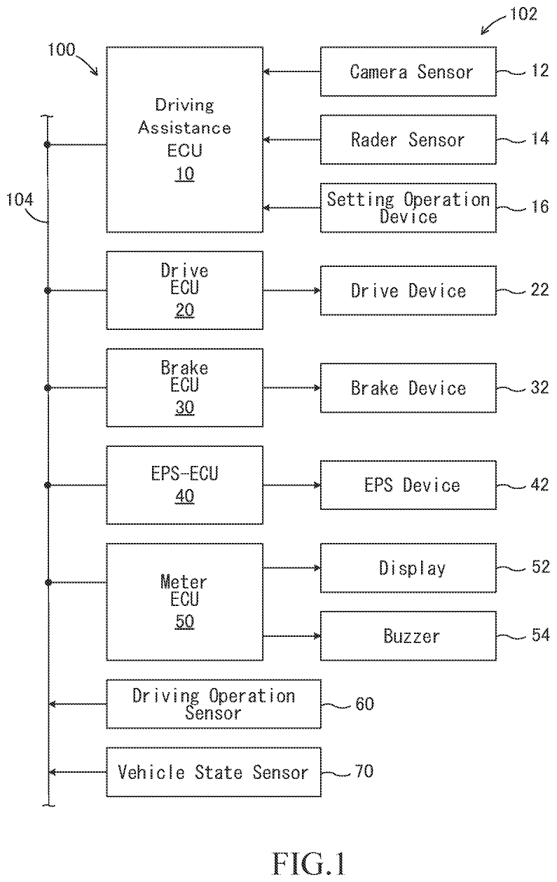

As shown in FIG. 1, a collision avoidance device 100 according to an embodiment of the disclosure is applied to a vehicle 102 and includes a driving assistance ECU 10. As shown in FIG. 1, the vehicle 102 includes a drive ECU 20, a brake ECU 30, an electric power steering ECU 40, and a meter ECU 50. ECU means an electronic control unit having a microcomputer as its main part. In the following description, the vehicle 102 will be referred to as own vehicle 102 as necessary to distinguish it from other vehicles, and the electric power steering will be referred to as EPS.

A microcomputer of each ECU includes a CPU, a ROM, a RAM, a readable and writable nonvolatile memory (N/M), an interface (I/F), and the like. The CPU implements various functions by executing instructions (programs, routines) stored in the ROM. Furthermore, these ECUs are connected to each other via a CAN (Controller Area Network) 104 so as to be able to exchange data (communicate). Therefore, detected values of sensors (including switches) connected to a specific ECU are transmitted to other ECUs as well.

The driving assistance ECU 10 is a central control unit that performs driving assistance control such as collision avoidance control and lane keeping control. Camera sensors 12 and radar sensors 14 are connected to the driving assistance ECU 10. The camera sensors 12 include four camera sensors for capturing front, rear, right, and left sides, but are not limited to four. The radar sensors 14 as radar devices include five radar sensors for acquiring target information of three-dimensional objects existing in the front area, the right front area, the left front area, the right rear area, and the left rear area, but are not limited to five. The camera sensors 12 and the radar sensors 14 function as ambient information acquisition devices that acquire information such as targets around the vehicle 102.

Although not shown in the figure, each camera sensor of the camera sensors 12 includes a camera unit that captures images of the surroundings of the vehicle 102, and a recognition unit that analyzes the image data captured by the camera unit and recognizes targets such as white lines on a road and other vehicles. The recognition unit supplies information about the recognized target to the driving assistance ECU 10 every time a predetermined time elapses.

Each radar sensor of the radar sensors 14 has a radar transmitting/receiving unit and a signal processor (not shown). The radar transmitting/receiving unit emits radio waves in the millimeter wave band (hereinafter referred to as “millimeter waves”) around the vehicle 102, and three-dimensional objects (for example, other vehicles, bicycles, guardrails, etc.) existing within the radiation range and receives reflected millimeter waves (i.e., reflected waves). Based on a phase difference between the transmitted millimeter wave and the received reflected wave, an attenuation level of the reflected wave, and a time from when the millimeter wave is transmitted to when the reflected wave is received, the signal processing unit acquires every predetermined time information concerning a distance between the own vehicle and a three-dimensional object, a relative speed between the own vehicle and the three-dimensional object, a relative position (direction) of the three-dimensional object with respect to the own vehicle, and the like, and supplies the information to the driving support ECU 10. LiDAR (Light Detection And Ranging) may be used instead of or in addition to the radar sensor 14.

Further, a setting operation device 16 is connected to the driving assistance ECU 10, and the setting operation device 16 is provided at a position to be operated by a driver. Although not shown in FIG. 1, the setting operation device 16 includes a collision avoidance control switch, and the driving assistance ECU 10 executes collision avoidance control when the collision avoidance control switch is on.

The drive ECU 20 is connected to a drive device 22 that accelerates the vehicle 102 by applying driving force to drive wheels (not shown in FIG. 1). The drive ECU 20 normally controls the drive device 22 so that the driving force generated by the drive device 22 changes according to the driving operation by the driver, and when the drive ECU 20 receives a command signal from the driving assistance ECU 10, the drive ECU 20 controls the drive device 22 based on the command signal.

Note that the drive device 22 is not limited to a combination of an internal combustion engine and an automatic transmission. That is, the drive device 22 may be any drive device known in the art such as a combination of an internal combustion engine and a continuously variable transmission, a so-called hybrid system that is a combination of an internal combustion engine and a motor, a so-called plug-in hybrid system, a combination of a fuel cell and a motor, or a motor.

The brake ECU 30 is connected to a brake device 32 that decelerates the vehicle 102 by applying braking force to wheels (not shown in FIG. 1). The brake ECU 30 normally controls the brake device 32 so that a braking force generated by the brake device 32 changes according to a braking operation by the driver, and, when the brake ECU 30 receives a command signal from the driving assistance ECU 10, the brake ECU 30 performs automatic braking by controlling the brake device 32 based on a command signal. When braking force is applied to the wheels, brake lamps (not shown in FIG. 1) are turned on.

An EPS device 42 is connected to the EPS-ECU 40. The EPS-ECU 40 controls the EPS device 42 in a manner known in the art based on a steering torque Ts and a vehicle speed V detected by a driving operation sensor 60 and a vehicle state sensor 70, which will be described later to control the steering torque and reduce the driver's steering burden. Further, the EPS-ECU 40 can steer steered wheels as necessary by controlling the EPS device 42. Therefore, the EPS-ECU 40 and the EPS device 42 function as a steering device that automatically steers the steered wheels as necessary.

Connected to the meter ECU 50 are a display 52 that displays a visual warning or the like indicating a state of control by the driving assistance ECU 10 and a buzzer 54 that sounds a warning sound, when there is a risk of the vehicle colliding with another vehicle. The display 52 may be, for example, a head-up display or a multi-information display that displays meters and various information, or may be a display of a navigation device.

The driving operation sensor 60 and the vehicle state sensor 70 are connected to the CAN 104. Information detected by the driving operation sensor 60 and the vehicle state sensor 70 (referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a drive operation amount sensor that detects an operation amount of an accelerator pedal, a braking operation amount sensor that detects a master cylinder pressure or a force applied to a brake pedal, and a brake switch that detects whether or not the brake pedal is operated. Furthermore, the driving operation sensor 60 includes a steering angle sensor that detects a steering angle θ, a steering torque sensor that detects a steering torque Ts, and the like.

The vehicle state sensor 70 includes a vehicle speed sensor that detects a vehicle speed V of the vehicle 102, a longitudinal acceleration sensor that detects longitudinal acceleration of the vehicle, a lateral acceleration sensor that detects lateral acceleration of the vehicle, a yaw rate sensor that detects a yaw rate of the vehicle, and the like.

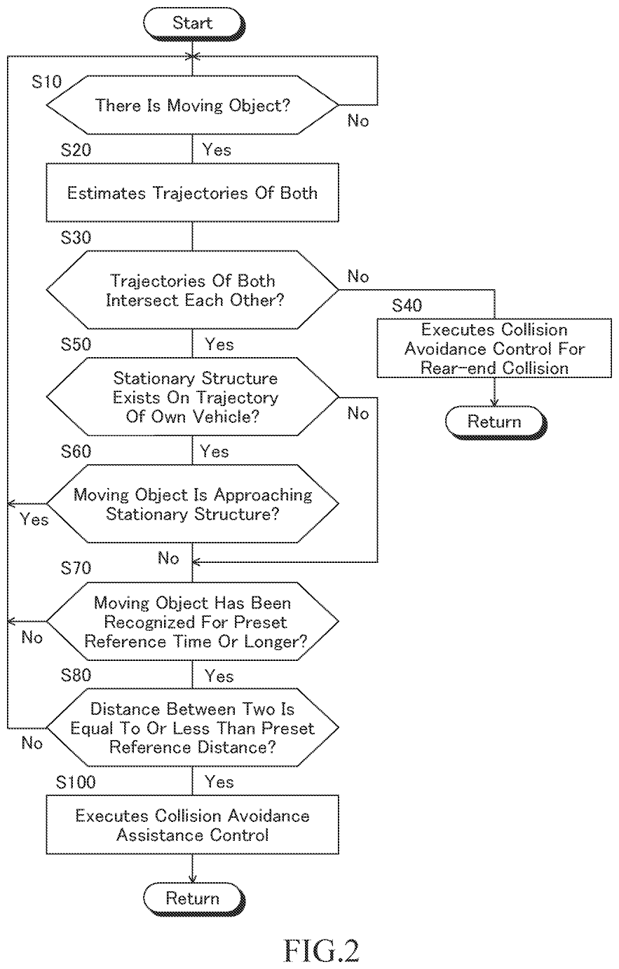

In the embodiment, the ROM of the driving assistance ECU 10 stores a collision avoidance control program corresponding to the flowchart shown in FIG. 2, and the CPU executes the collision avoidance control according to the program. The collision avoidance control method according to the embodiment is executed by executing collision avoidance control.

### <Collision Avoidance Control Routine in the Embodiment>

Next, the collision avoidance control routine in the embodiment will be described with reference to the flowchart shown in FIG. 2. The collision avoidance control according to the flowchart shown in FIG. 2 is executed by the CPU of the driving assistance ECU 10 when the collision avoidance switch (not shown in FIG. 1) is turned on.

First, in step S10, the CPU determines whether or not there is a moving object in front of the own vehicle 102 including diagonally in front, that is, whether or not the moving object is detected in front of the own vehicle 102 including diagonally in front by the radar sensor 14 at least. When the CPU makes a negative determination, it once ends the present control, and when it makes an affirmative determination, it advances the present control to step S20.

In step S20, the CPU estimates trajectories of the vehicle 102 and the moving object based on at least the detection result of the radar sensor 14, for example, as extensions of trajectories of the own vehicle 102 and the moving object. When estimating the trajectory of the own vehicle 102, at least a motion state quantity such as a yaw rate of the own vehicle may be considered.

In step S30, the CPU determines whether the trajectories of the own vehicle 102 and the moving object intersect each other and the own vehicle and the moving object are approaching each other, that is, whether the own vehicle 102 and the moving object whose trajectories cross each other collide. When the CPU makes an affirmative determination, it advances the present control to step S50, and when it makes a negative determination, it advances the present control to step S40.

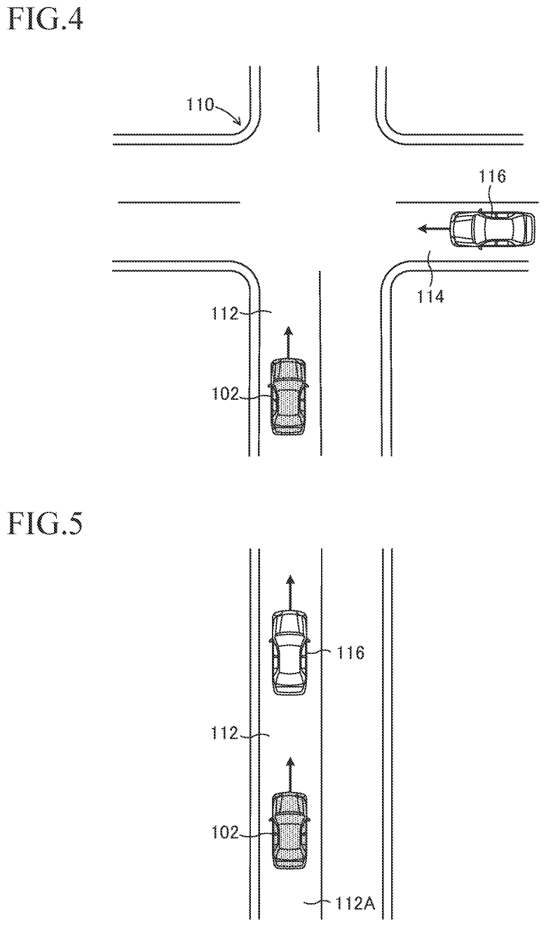

As shown in FIG. 4, when the own vehicle 102 approaches an intersection 110 and another vehicle 116 as a moving object moves toward the intersection on a road 114 intersecting a road 112 on which the own vehicle 102 is traveling, an affirmative determination is made in step S30. The intersection is not limited to a crossroad and a T-shaped road where the roads 112 and 114 intersect at 90°, and may be a Y-shaped road where two roads intersect at an angle other than 90°. On the other hand, as shown in FIG. 5, the own vehicle 102 is traveling on a lane 112A of the road 112, and another vehicle 116 as a moving object is ahead of the own vehicle 102 and is moving in the same direction as the own vehicle or in the opposite direction, a negative determination is made in step S30.

In step S40, the CPU executes collision avoidance control for rear-end collision. In collision avoidance control for a rear-end collision, when the other vehicle 116 moves in front of the own vehicle 102 in the same direction as the own vehicle and there is a risk of the own vehicle colliding with the other vehicle, a collision avoidance assistance control is executed to avoid the rear-end collision. Note that them collision avoidance control for rear-end collision may be arbitrary rear-end collision avoidance control known in the art, such as the collision avoidance control in the collision avoidance device described in Japanese Patent Application Laid-Open No. 2018-106233, for example.

In step S50, the CPU determines whether or not a stationary structure exists on the trajectory of the own vehicle 102 based at least on the detection result of the radar sensor 14. When the CPU makes a negative determination, it advances the present control to step S70, and when the CPU makes an affirmative determination, it advances the present control to step S60. When at least the radar sensor 14 detects a stationary object on the trajectory of the own vehicle 102 and the CPU determines that the stationary object extends beyond a width of a lane in which the own vehicle is traveling and traverses the trajectory of the own vehicle, the stationary object is determined to be a stationary structure. In addition, a detection result by the camera sensor 12 may be taken into consideration when determining whether or not there is a stationary structure.

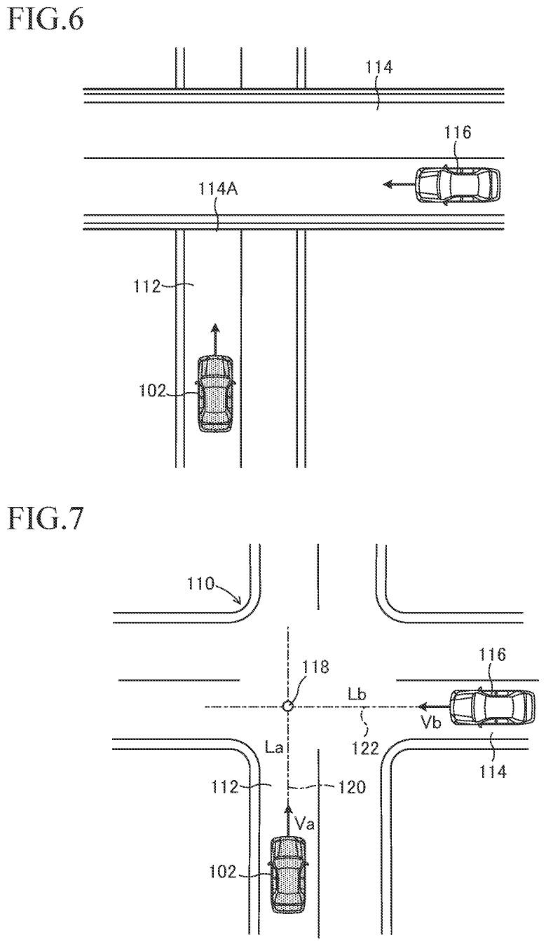

For example, as shown in FIG. 6, when the road 114 that seems to intersect the road 112 on which the own vehicle 102 is traveling is an elevated road, a section 114A of the elevated road in front of the own vehicle 102 is determined to be a stationary structure. This is the same when the road 112 on which the own vehicle 102 is traveling is an underpass road that once descends and passes under the road 114. When the road 112 on which the own vehicle 102 is traveling is an overpass road that rises once and passes above the road 114, the road 112 itself is determined to be a stationary structure.

In step S60, the CPU determines whether or not the moving object is approaching the stationary structure based on at least the detection result of the radar sensor 14. When the CPU makes an affirmative determination, it temporarily ends the present control without executing steps S70 to S100, and when the CPU makes a negative determination, it advances the present control to step S70.

In step S70, the CPU determines whether or not the moving object has been recognized by the radar sensor 14 or the like for a preset reference time (positive constant) or longer. When the CPU makes a negative determination, it once terminates the present control without executing steps S80 and S100, and when the CPU makes an affirmative determination, it advances the present control to step S80.

In step S80, the CPU determines whether or not a distance between the own vehicle 102 and the moving object is equal to or less than a preset reference distance (positive constant). When the CPU makes a negative determination, it once terminates the present control without executing step S100, and when the CPU makes an affirmative determination, it advances the present control to step S100. Note that the reference distance may be a positive constant, but may variably be set according to a rate of decrease in the distance between the own vehicle 102 and the moving object so that it increases as the rate of decrease in the distance between the own vehicle 102 and the moving object increases.

In step S100, the CPU executes the collision avoidance assistance control. Specifically, the CPU outputs a command signal to the meter ECU 50 to display a visual warning on the display 52 to the effect that the own vehicle 102 may collide with the moving object, and to sound the buzzer 54 to issue an auditory warning to the effect that there is a risk that the own vehicle 102 will collide with the moving object. Thus, warnings are issued to warn the driver that the own vehicle may collide with the moving object. Further, the CPU outputs a command signal to the brake ECU 30 to decelerate the own vehicle 102 by automatic braking by the brake device 32, thereby avoiding the collision of the own vehicle 102 with the moving object. When it is determined that the own vehicle 102 should be accelerated in order to avoid a collision, the own vehicle 102 may be accelerated by automatic acceleration by the drive device 22. That is, the collision avoidance assistance control may include a control for performing automatic acceleration/deceleration of the own vehicle so as to reduce the risk of the own vehicle colliding with a moving object.

In the embodiment, in step S30, it is determined whether or not there is a possibility of collision between the own vehicle 102 and the moving object whose trajectories cross each other, and in steps S50 and S60, it is determined whether or not the own vehicle 102 and the moving object are moving along trajectories with different heights. Furthermore, in steps S70 and S80, it is determined whether or not there is a high risk of collision between the own vehicle 102 and the moving object traveling along trajectories that intersect each other at the same height. When it is determined that there is a high risk of collision between the own vehicle 102 and the moving object, in step S100, a visual warning and an auditory warning are issued and an acceleration/deceleration control amount of the own vehicle 102 is automatically controlled to avoid collision between the own vehicle 102 and the moving object.

### Collision Avoidance Control Routine in Modified Example

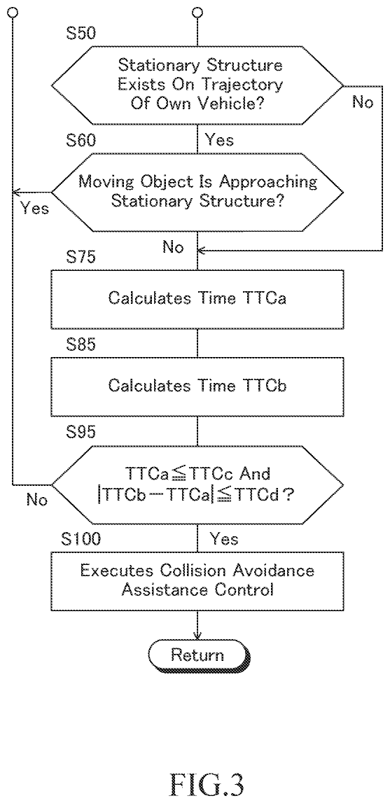

FIG. 3 is a flow chart showing a main part of a collision avoidance control routine in a modified example. In FIG. 3, steps that are the same as the steps shown in FIG. 2 are given the same step numbers as the step numbers given in FIG. 2.

As can be seen from the comparison between FIG. 3 and FIG. 2, in the modified example, steps S75 to S95 are executed instead of steps S70 and S80 in the embodiment.

FIG. 7 shows, similarly to FIG. 4, a situation in which the own vehicle 102 is likely to collide with another vehicle 116 approaching from the side at an intersection 110. In FIG. 7, reference numeral 118 indicates collision prediction points of the own vehicle 102 and the other vehicle 116. It is assumed that the own vehicle 102 is traveling along a trajectory 120 at a vehicle speed Va toward a collision prediction point 118, and the other vehicle 116 is traveling along a trajectory 122 at a vehicle speed Vb toward the collision prediction point 118. The collision prediction point 118 is assumed to be an intersection of trajectories 120 and 122.

In step S75, the CPU estimates a distance La from the own vehicle 102 to the collision prediction point 118 based on the detection result of the radar sensor 14, and calculates a time TTCa for the own vehicle 102 to reach the collision prediction point 118 according to the following equation (1).

TTCa=La/Va (1)

In step S85, the CPU estimates a distance Lb from the other vehicle 116 to the collision prediction point 118 and a vehicle speed Vb of the other vehicle based on the detection result of the radar sensor 14. Furthermore, the CPU calculates a time TTCb for the other vehicle 116 to reach the collision prediction point 118 according to the following equation (2).

TTCb=Lb/Vb (2)

In step S95, the CPU determines whether or not there is a high risk of collision between the own vehicle 102 and the other vehicle 116 by determining whether or not the following formulas (3) and (4) hold. When the CPU makes a negative determination, it once terminates the present control without executing step S100, and when the CPU makes an affirmative determination, it advances the present control to step S100.

TTCa≤TTCc (3)

|TTCb−TTCa|≤TTCd (4)

Note that the reference value TTCc in the above equation (3) is a reference value for determining a start of the collision avoidance assistance control, and may be a positive constant. The reference value TTCd in the above formula (4) is a reference value for determining the possibility of collision between the own vehicle 102 and the other vehicle 116, and may be a positive constant. The left side of the above equation (4) becomes smaller as the possibility of collision between the own vehicle 102 and the other vehicle 116 becomes higher.

In the modified example, as in the embodiment, in step S30, it is determined whether or not there is a possibility that the own vehicle 102 and the moving object whose trajectories cross each other will collide, and in steps S50 and S60, it is determined whether or not the own vehicle 102 and the moving object are moving along trajectories with different heights. Further, in steps S75 to S95, it is determined whether or not there is a high risk of collision between the own vehicle 102 and the moving object traveling along trajectories that intersect each other at the same height. When it is determined that there is a high risk of collision between the own vehicle 102 and the moving object, a visual warning and an auditory warning are issued in step S100, and an acceleration/deceleration of the own vehicle 102 is automatically controlled to avoid the collision between the own vehicle 102 and the moving object.

As can be seen from the above description, according to the embodiment and the modified example, when it is determined that the own vehicle 102 and the moving object are moving along trajectories with different heights (S50 and S60), the collision avoidance assistance control (S100) is not executed. That is, no warning is issued and acceleration/deceleration control of the own vehicle 102 is not executed, and a process equivalent to reducing the control amount of the collision avoidance assistance control to zero is performed.

Therefore, in a situation in which a moving object such as another vehicle approaching from the side of the own vehicle moves to a position different in height from the own vehicle, collision avoidance assistance control, i.e., the control for performing automatic acceleration/deceleration of the own vehicle and the issuing of the warnings can be prevented from being executed unnecessarily. Therefore, it is possible to prevent occurrence of adverse effects due to the execution of the collision avoidance assistance control. That is, it is possible to prevent a vehicle speed from varying unintentionally by the driver, and to prevent occupants from being annoyed by unnecessary warnings.

Moreover, since a radar device capable of detecting a height of another vehicle, such as an expensive radar device having antenna elements arranged at a plurality of positions with different heights, is unnecessary, it is possible to avoid making the collision avoidance device expensive.

As shown in FIG. 7, when there is a high possibility that the own vehicle will collide with another vehicle approaching from the side at an intersection of a grade intersection, no stationary structure is detected on the trajectory of the own vehicle (S50), it is not determined that the moving object is approaching a stationary structure (S60). Therefore, since the collision avoidance assistance control is performed, the collision avoidance can be assisted by the collision avoidance assistance control.

Further, according to the embodiment and the modified example, in step S50, when a stationary object is detected on the trajectory of the own vehicle 102 and it is determined that the stationary object extends across the trajectory of the own vehicle beyond a width of a lane in which the own vehicle is traveling, the stationary object is determined to be a stationary structure.

Therefore, for example, road signs, traffic lights, large parked vehicles, etc. can be prevented from being erroneously determined as stationary structures, and it is possible to accurately determine whether or not a moving object approaching from the side of the own vehicle is moving at a height position different from that of the own vehicle.

In particular, according to the modified example, steps S75 to S95 are performed to determine whether there is a high risk of collision between the own vehicle and a moving object. Therefore, it is possible to determine whether or not there is a high risk of collision between the own vehicle and the moving object with high accuracy as compared to where steps S70 and S80 of the embodiment are performed.

Although the present disclosure has been described in detail with reference to the specific embodiment and modified example, it will be apparent to those skilled in the art that the present disclosure is not limited to the above-described embodiment and modified example, and various other embodiments are possible within the scope of the present disclosure.

For example, in the above-described embodiment and modified example, when it is determined that the own vehicle 102 and a moving object are moving along trajectories with different heights (S50 and S60), the collision avoidance assistance control (S100) is not executed. That is, no warning is issued and the automatic acceleration/deceleration control of the own vehicle 102 is not executed, and a process equivalent to reducing a control amount of the collision avoidance assistance control to zero is performed.

However, the automatic acceleration/deceleration control may be executed with a reduced control amount of the acceleration/deceleration control. In that case, it is possible to reduce a fluctuation of acceleration/deceleration of the own vehicle that is not dependent on a driving operation of a driver, that is, a fluctuation of a vehicle speed that is not intended by the driver.

A warning may be issued with a reduced control amount for the warning. A reduction in a control amount of the warning may be achieved in an audible warning by, for example, reducing its volume, and in a visual warning by reducing a size of texts of the warning or lowering brightness of the texts. Further, a reduction in the control amount of the warning may be achieved by reducing the types of warnings, e.g., omitting one of the auditory and visual warnings. In these cases, a degree of appeal of the warning is reduced, so that it is possible to reduce a possibility that an occupant or occupants will feel annoyed by an unnecessary warning.

In the above embodiment and modified example, the radar device is a radar sensor that emits millimeter waves as radar waves. However, the radar device in the present disclosure may be a radar device that emits laser light as radar waves or a radar device that emits sound waves as radar waves.

In the above embodiment and modified example, the collision avoidance assistance control includes the automatic acceleration/deceleration control and the warning issuing, but may be only one of the automatic acceleration/deceleration control and the warning issuing. Further, in addition to the automatic acceleration/deceleration control and/or the warning issuing, automatic steering of steerable wheels may be performed to avoid a collision. In that case, when it is determined that the own vehicle and the moving object are moving along trajectories with different heights, a control amount of the automatic steering may be reduced.

In the above embodiment and modified example, determination of whether or not there is a possibility of collision between the own vehicle and a moving object whose trajectories intersect each other is made in step S30 by determining whether the trajectories of the own vehicle and the moving object intersect each other and the two are approaching each other. However, the determination of the possibility of collision is the same determination as in steps S75 to S95 of the modified example in which the reference values of the above equations (3) and (4) are positive constants larger than the reference values TTCc and TTCd, respectively.

In the above embodiment and modified example, the determination of whether or not there is a high risk of collision between the own vehicle and a moving object is performed in steps S70 and S80 in the embodiment, and performed in steps S75 to S95 in the modified example. However, the determination of whether there is a high risk of collision between the own vehicle and a moving object may be made in any manner known in the art.

What is claimed is:

1. A collision avoidance device comprising a radar device that detects an object around an own vehicle, and an electronic control unit that is configured to execute a collision avoidance assistance control to avoid a collision when it is determined that there is a risk of the own vehicle colliding with the object detected by the radar device, wherein
the electronic control unit is configured, even if the radar device detects a moving object that moves in a direction approaching a trajectory of the own vehicle so as to cross the trajectory and it is determined that there is a risk of the own vehicle colliding with the moving object, to reduce a control amount of the collision avoidance assistance control when a stationary structure is detected on the trajectory by the radar device and it is determined that the moving object is approaching the stationary structure.

2. The collision avoidance device according to claim 1, wherein the electronic control unit is configured, when the radar device detects a stationary object on the trajectory of the own vehicle and it is determined that the stationary object extends across the trajectory beyond a width of a lane in which the own vehicle is traveling, to determine that the stationary object is a stationary structure.

3. The collision avoidance device according to claim 1, wherein the collision avoidance assistance control is a control for performing automatic acceleration/deceleration of the own vehicle so as to reduce the risk of the own vehicle colliding with the moving object, and the electronic control unit is configured to reduce a control amount of the control for performing the automatic acceleration/deceleration of the own vehicle.

4. The collision avoidance device according to claim 3, wherein the electronic control unit is configured not to perform the automatic acceleration/deceleration of the own vehicle by reducing the control amount of the control for performing the automatic acceleration/deceleration to zero.

5. The collision avoidance device according to claim 1, wherein the collision avoidance support control is a control for issuing a warning to warn a driver that there is a risk of the own vehicle colliding with the moving object, and the electronic control unit is configured to reduce a control amount of the control for issuing the warning so that a degree of appeal of the warning is reduced.

6. The collision avoidance device according to claim 5, wherein the electronic control unit is configured not to issue a warning by reducing the control amount of the control for issuing a warning to zero.

7. A collision avoidance method that comprises a step of acquiring information about an object around an own vehicle detected by a radar device, a step of determining whether or not there is a risk of the own vehicle colliding with the object detected by the radar device, and a step of performing collision avoidance assistance control for avoiding a collision when it is determined that there is the risk, wherein
the collision avoidance method further comprises a step of determining, when a moving object that moves in a direction approaching a trajectory of the own vehicle so as to cross the trajectory is detected by the radar device and it is determined that there is a risk of the own vehicle colliding with the moving object, whether or not a stationary structure is detected on the trajectory by the radar device and whether or not the moving object is approaching the stationary structure, and a step of reducing a control amount of the collision avoidance assistance control when a stationary structure is detected on the trajectory by the radar device and it is determined that the moving object is approaching the stationary structure.

8. A collision avoidance program that causes an electronic control unit mounted on an own vehicle to execute a step of acquiring information about an object around an own vehicle detected by a radar device, a step of determining whether or not there is a risk of the own vehicle colliding with the object detected by the radar device, and a step of performing collision avoidance assistance control for avoiding a collision when it is determined that there is the risk, wherein
the collision avoidance program further comprises a step of determining, when a moving object that moves in a direction approaching a trajectory of the own vehicle so as to cross the trajectory is detected by the radar device and it is determined that there is a risk of the own vehicle colliding with the moving object, whether or not a stationary structure is detected on the trajectory by the radar device and whether or not the moving object is approaching the stationary structure, and a step of reducing a control amount of the collision avoidance assistance control when a stationary structure is detected on the trajectory by the radar device and it is determined that the moving object is approaching the stationary structure.
